(19) United States
(12) Patent Application Publication
(10) Pub. No.: US 2026/0339074 A1
(43) Pub. Date: Oct. 29, 2026

(54) OPTICAL RELAY DEVICE

(71) Applicant: Panavision International, L.P., Woodland Hills, CA (US)

(72) Inventor: Daniel Keith Sasaki, Glendale, CA (US)

(21) Appl. No.: 19/660,064

(22) Filed: Apr. 27, 2026

Related U.S. Application Data
(60) Provisional application No. 63/796,307, filed on Apr. 28, 2025.

(51) Int. Cl. G02B 13/00; G02B 9/64

(52) U.S. Cl. CPC G02B 13/005; G02B 9/64

(57) ABSTRACT

Optical relay devices and systems comprise a housing having a cylindrical wall structure with a first axial end to connect with a first large format camera lens and an opposite second axial end to connect with a second small taking camera lens having a digital image sensor. A lens group is disposed inside of the housing and comprises a plurality of lens elements that are positioned, sized, and/or configured to provide a desired reduction in image transmitted from the first camera lens to the second camera lens for image capture. The lens elements may be spherical and/or anamorphic depending on the desired form of image capture that is desired. The lens group may have a PNNP power structure. The optical relay device produces an aerial intermediate image within the housing without the use of a ground glass element, thereby providing a clearer image for capture by the second camera.

### CROSS-REFERENCE TO RELATED APPLICATIONS

This application claims the benefit of U.S. Provisional Patent Application No. 63/796,307 filed Apr. 28, 2025, which is hereby incorporated by reference in its entirety.

### FIELD

Devices, systems, and/or methods as disclosed herein are configured to be used with portable devices such as small sensor cameras, cell phones/smart phones that include small cameras. More specifically, devices, systems, and/or methods as disclosed herein are in the form of optical relay devices, systems, and/or methods that are specially developed to provide an enhanced degree/quality, and/or artistic/cinematic look of optical images (still or video) captured by such portable devices comparable to optical images provided by large format lenses, e.g., cinematic lenses.

### BACKGROUND

The existence and use of personal, e.g., handheld, devices that may be in the form of small portable cameras, cellular phones/smartphones that include cameras, or other small portable devices that include cameras are known. Such devices are configured for easy user portability and use for photo or video capture by the user. With reference to cellular phones or smartphones, much of recent cell phone development has included the cellular phone's camera, camera lens, and related on-board image processing technology to enable such devices to provide an improved degree/quality of both still and video image capture.

While the quality of such portable device, e.g., cellular phone, cameras, lenses, and on-board processing technology has improved, the features of and resulting image quality, e.g., still and/or video, provided by such portable cell phone cameras is still lacking, e.g., due to limited effective focal length and the like, when compare to still and/or video images produced by large format lenses, such as the large format camera lenses, i.e., cinematic camera lenses, that are specially-developed to provide an artistic or cinematic look as used with camera and camera systems for movie production and the like. Many enthusiasts and professionals seek additional capabilities, such as greater focal length, better zoom, macro, or wide-angle options, or the like.

It is, therefore, desired that a device or system be specially developed to enable such portable devices such as cellular phones/smartphones and the like comprising cameras to provide an improved degree/quality of image capture comparable to that of such large format lenses, thereby infusing a desired artistic or cinematic look, and/or providing such features of greater focal length, better zoom, macro, or wide-angle options, or the like.

### SUMMARY

Optical relay devices and systems disclosed herein generally comprise a housing having a first axial end and a second axial end opposite the first axial end. The housing comprises a wall structure that defines an internal opening extending axially through the housing between the first and second axial ends. In an example, the housing first axial end is configured to connect with an end of a first camera lens, e.g., an objective lens, and the housing second axial end is configured to connect with a second camera lens of a camera system comprising a camera for image capture. In an example, the first camera lens is larger in diameter that the second camera lens. In an example, the first camera lens is a large format camera lens. In an example, the second camera lens may be of a cellular or smart phone having a digital image sensor. In an example, the housing wall structure has an outside surface configured to accommodate attachment or rigging with a mounting device. In an example, the housing may be formed from a structurally rigid material such as a plastic, polymeric, or metallic material, e.g., such as those materials used to make the housings of camera lenses.

The optical relay device comprises a lens group that is disposed within the housing wall structure and located between the housing first and second axial ends. In an example, the lens group comprises a plurality of lenses or lens elements that are configured and positioned within the housing to converge and reduce the image as received by the first camera lens to an image that corresponds to the second camera lens for image capture by the camera system camera. In an example, the plurality of lens elements are arranged in series. In an example, one or more of the lens elements positioned inside the housing adjacent the first axial end are sized larger in diameter then one or more of the lens elements positioned inside the housing adjacent the second axial end. In an example, the lens elements may be formed from glass. If desired, the glass type and/or one or more of the surfaces of the glass may be treated to provide a desired optical function or effect.

In an example, the first camera lens and second camera lens are aligned along a common optical axis that extends longitudinally through the optical relay device. In an example, the optical relay device is telecentric. In an example, the optical relay device lens group is configured to produce an aerial intermediate image within the housing between the first and second camera lenses without the use of a ground glass element. In an example, the series of lens elements of the lens group are each fixedly attached and not movable within the housing internal opening. In an example, one or more of the lens elements of the lens group are cylindrical in configuration to produce an anamorphic image. In such example where the optical relay device produces an anamorphic image the optical relay device may have an anamorphic squeeze of from about 1.35× to about 3×. In an example, all of the lens elements of the lens group are spherical and no lens elements are cylindrical. In an example, the lens group (whether having one or more cylindrical lens element or having entirely spherical lens elements) has a PNNP power structure.

In an example, where the optical relay device has a lens group of entirely spherical lens elements (e.g., a non-anamorphic embodiment), the lens group may comprise eight lens elements. In such example, the lens group may comprise a first lens or first lens element positioned adjacent the housing first axial end and having a plano-convex configuration. In such example, the lens group may comprise a second lens positioned adjacent the first lens and having a biconvex configuration. In such example, the lens group may comprise a third lens positioned adjacent the second lens and having a biconvex configuration. In such example, the lens group may comprise a fourth lens positioned adjacent the third lens and having biconcave configuration. In such example, the lens group may comprise a fifth lens positioned adjacent the fourth lens and having a convex concave configuration. In such example, the lens group may comprise a sixth lens positioned adjacent the fifth lens and having a convex concave configuration. In such example, the lens group may comprise a seventh lens positioned adjacent the sixth lens and having a convex concave configuration. In such example, the lens group may comprise an eighth lens interposed between the seventh lens and the second axial end and having a biconvex configuration.

In such non-anamorphic example of the optical relay device, the second lens has a first convex surface adjacent the housing first axial end defined by a radius of curvature that is greater than a second convex surface adjacent the third lens. In such example, the third lens has a first convex surface adjacent the second lens defined by a radius of curvature that is less than a second convex surface adjacent the fourth lens. In such example, the fourth lens has a first concave surface adjacent the third lens defined by a radius of curvature that is less than a second concave surface adjacent the fifth lens. In such example, the fifth lens has a convex surface adjacent the fourth lens defined by a radius of curvature that is less than a concave surface adjacent the sixth lens. In such example, the sixth lens has a convex surface adjacent the fifth lens defined by a radius of curvature that is less than a concave surface adjacent the seventh lens. In such example, the seventh lens has a convex surface adjacent the sixth lens defined by a radius of curvature that is less than a concave surface adjacent the eighth lens. In such example, the eighth lens has a first convex surface adjacent the seventh lens and a second convex surface adjacent the housing second axial end that have a radius of curvature that are approximately the same. In such example, all of the lenses or lens elements are spherical.

In an example where the optical relay device produces an anamorphic image, the lens group may comprise a first lens or first lens element that is the same as that described above positioned adjacent the housing first axial end, wherein the first lens is spherical and has a plano-convex configuration. In such anamorphic example, the lens group has a second lens that is cylindrical, positioned adjacent the first lens, and that has a biconvex configuration. In such anamorphic example, the lens group has a third lens that is cylindrical, positioned adjacent the second lens, and that has a biconcave configuration. In such anamorphic example, the lens group has a fourth lens that is spherical, positioned adjacent the third lens, and that has a convex concave configuration. In such anamorphic example, the lens group has a fifth lens that is spherical, positioned adjacent the fourth lens, and that has a convex concave configuration. In such anamorphic example, the lens group has a sixth lens that is spherical, positioned adjacent the fifth lens, and that has a convex concave configuration. In such anamorphic example, the lens group has a seventh lens that is spherical, positioned adjacent the sixth lens, and that has a biconvex configuration.

In such anamorphic example of the optical relay device, the second lens has a first convex surface adjacent the housing first axial end defined by a radius of curvature that is less than a second convex surface adjacent the third lens. In such anamorphic example, the third lens has a first concave surface adjacent the second lens defined by a radius of curvature that may be the same or different than a second concave surface adjacent the fourth lens. In such example, the fourth lens has a convex surface adjacent the fourth lens defined by a radius of curvature that is greater than a concave surface adjacent the fifth lens. In such anamorphic example, the fifth lens has a convex surface adjacent the fourth lens defined by a radius of curvature that is greater than a concave surface adjacent the sixth lens. In such anamorphic example, the sixth lens has a convex surface adjacent the fifth lens defined by a radius of curvature that is greater than a concave surface adjacent the seventh lens. In such anamorphic example, the seventh lens has a first convex surface adjacent the sixth lens and a second convex surface adjacent the housing second axial end that have a radius of curvature that are approximately the same. In such anamorphic example, the optical relay device is configured to produce an aerial intermediate image within the housing without the use of a ground glass element.

### BRIEF DESCRIPTION OF THE DRAWINGS

These and other features and aspects of optical relay devices and systems and methods of making and/or using the same as disclosed herein will be appreciated as the same becomes better understood by reference to the following detailed description when considered in connection with the accompanying drawings where:

FIGS. 1 and 2 are perspective views of an example optical relay device as disclosed herein as used with a large format lens at one end and a cellular phone/smart phone camera at an opposite end;

FIG. 3 is a perspective view of an example optical relay device as disclosed herein as connected with a small sensor device such as a cellular phone/smart phone camera at one end;

FIG. 4 is a perspective view of the example optical relay device of FIG. 3 as unattached at opposed ends;

FIG. 5 is a side view of the example optical relay device of FIG. 4;

FIG. 6 is a side perspective cross-sectional view of the example optical relay device of

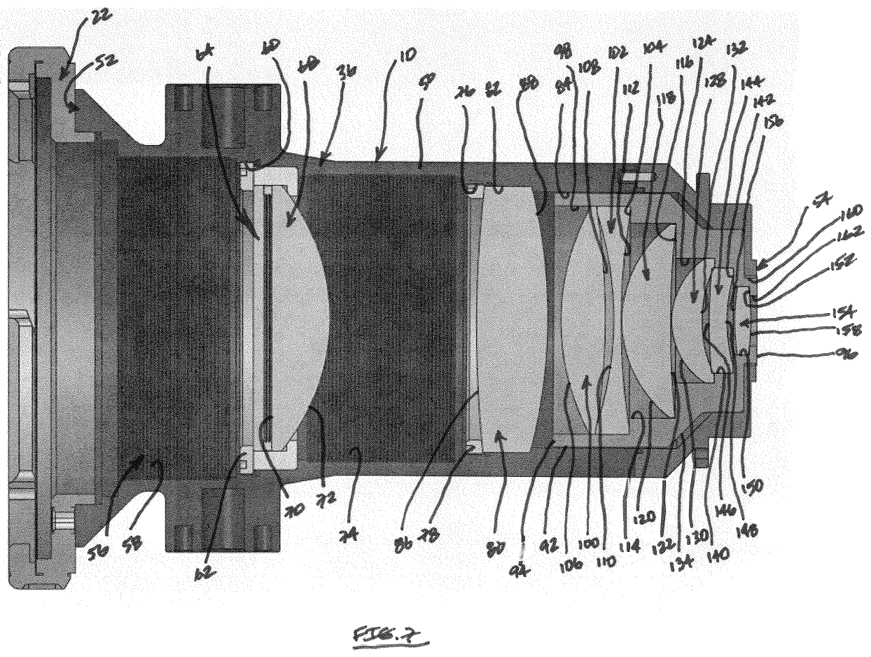

FIG. 5;

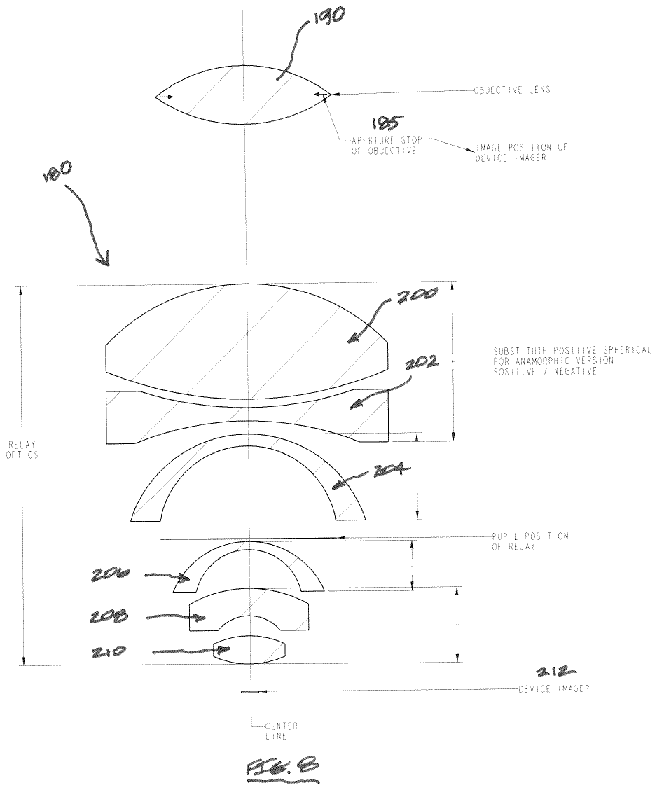

FIG. 7 is a side cross-sectional view of the example optical relay device of FIG. 6; and

FIG. 8 is a side cross-sectional view of an example optical relay device as disclosed herein comprising a lens group having one or more anamorphic lenses or lens elements.

### DESCRIPTION

Optical relay devices and systems as disclosed herein generally comprise a device that is specially constructed to attach with a first camera lens at one axial end and a second camera lens at a second axial end, and that comprises a series of lenses disposed inside the device that are specially configured and combined to achieve a desired reduction of image size as produced by the first camera lens and as received by the second camera lens. Generally, optical relay devices and systems as disclosed herein are configured to provide a desired degree of optical image enhancement to the second camera lens that is otherwise not inherent in the second camera lens. In an example, the first camera lens is a large format camera lens such as one having cinematic optical features used in motion picture production and the like, and in an example the second camera lens is a much smaller lens that is part of a camera system including a camera and a small digital image sensor that is used in a small portable device such as a small portable camera, cellular phone, smartphone, and the like.

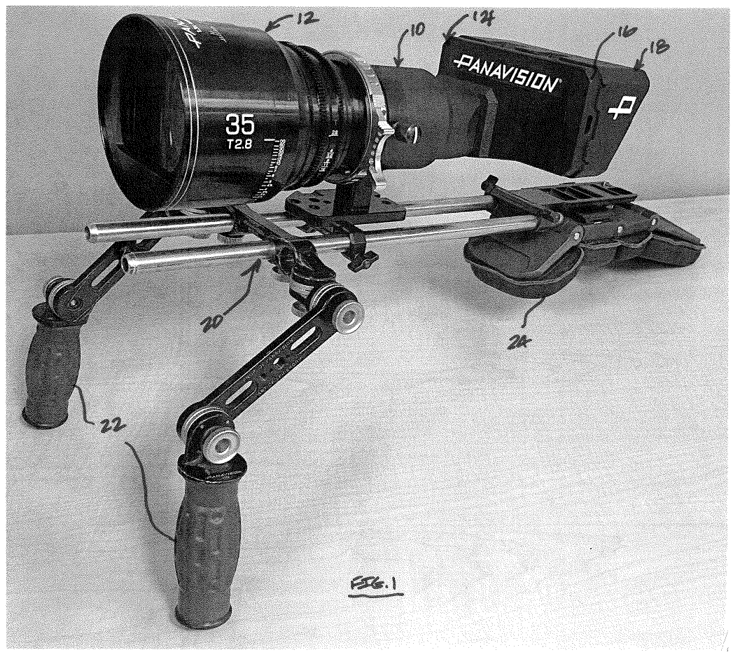

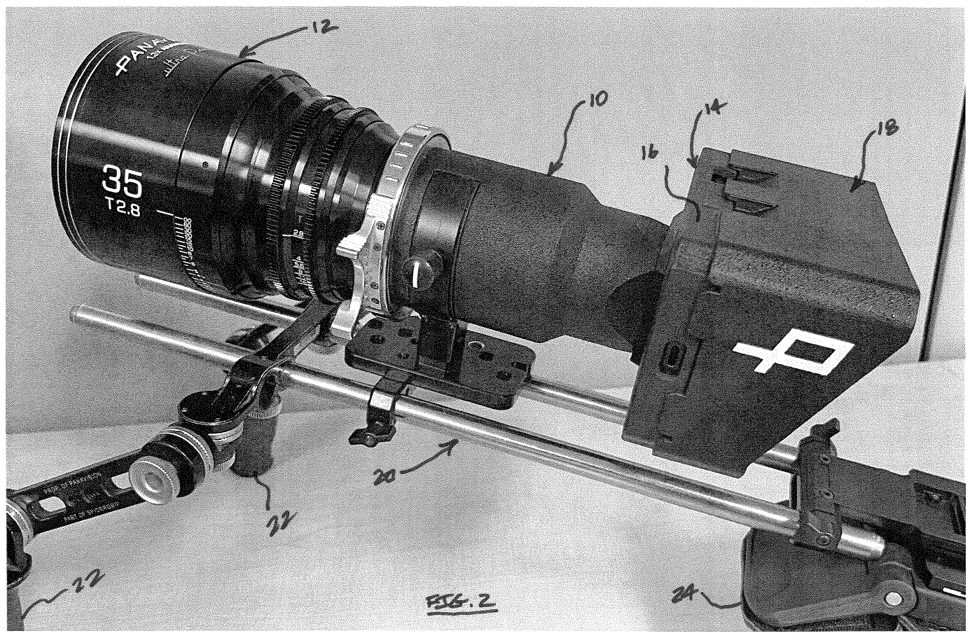

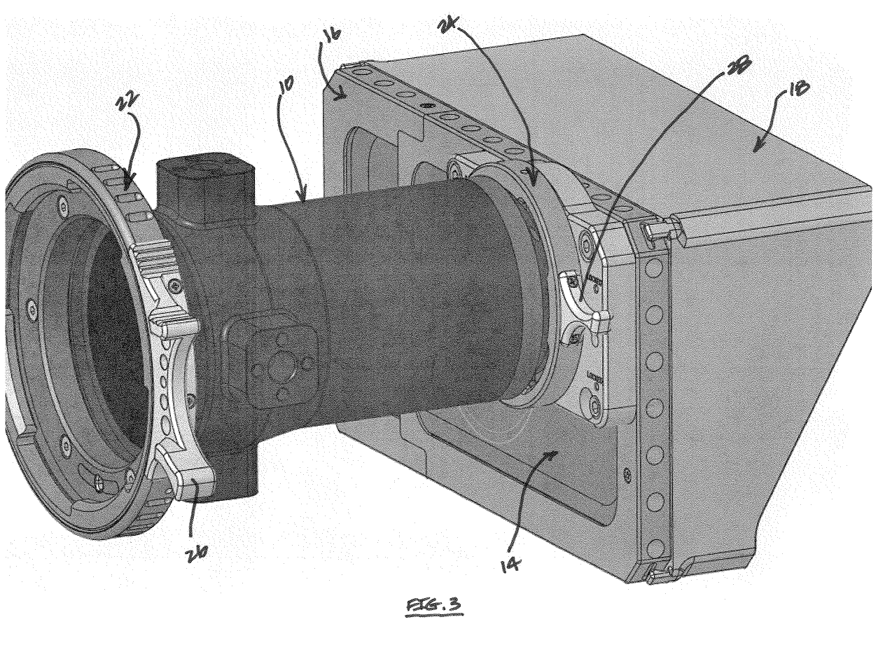

FIGS. 1 and 2 illustrate an example embodiment of an optical relay device 10 as disclosed herein as connected with a first camera lens 12, e.g., a large format cinematic camera lens, at one axial end of the device, and as connected with a second camera lens of a small portable device 14, e.g., a cellular phone camera, at a second axial end of the device opposite the first axial end. In the illustrated example, the optical relay device 10 is shown as it would be used by a user with ancillary devices/equipment attached thereto. In an example, the optical relay device second axial end may be connected or attached with an enclosure 16 or cage that is enclosed around or otherwise connected with at least part of the portable device 14 for the purpose of providing a stable mounting attachment between the optical relay device and the portable device so that there is no undesired movement between the optical relay device 10 and the second camera lens. The enclosure or cage 16 is one that attaches around at least part of a housing of the portable device 14, and has an opening so as to not obstruct the image being passed from the optical relay device to the second camera lens. If desired, a viewing hood 18 or the like may be attached to the portable device 14 to enable a user to view a screen of the portable device, e.g., the screen of a cellular phone or smartphone, so as to enable the user to better see the image that is relayed to the portable device under surrounding ambient light conditions that may otherwise make viewing the image difficult.

In an example, the optical relay device 10 may be configured to enable connection or attachment with rigging equipment to enable the optical relay device 10, and the first and second lenses attached thereto, to be moved or used in a manner intended for a desired image capture application, such as for use in capturing a video image during production of a movie or the like. In an example, the optical relay device 10 may include one or more mounting points disposed along the housing (as better described and illustrated below) and configured to enable the optical relay device 10 to be attached to such rigging equipment. In the example illustrated, the optical relay device 10 is connected with rigging equipment 20 that is configured with handles 22 and a shoulder pad 24 to enable the optical relay device and the lenses attached thereto to be carried by a user during a video image capture use application. While a particular type of rigging equipment 20 for use with the optical relay device 10 has been described and illustrated, it is to be understood that optical relay devices 10 as disclosed herein may be used with any type of rigging equipment that may be configured differently than that illustrated as called for by the particular end-use application.

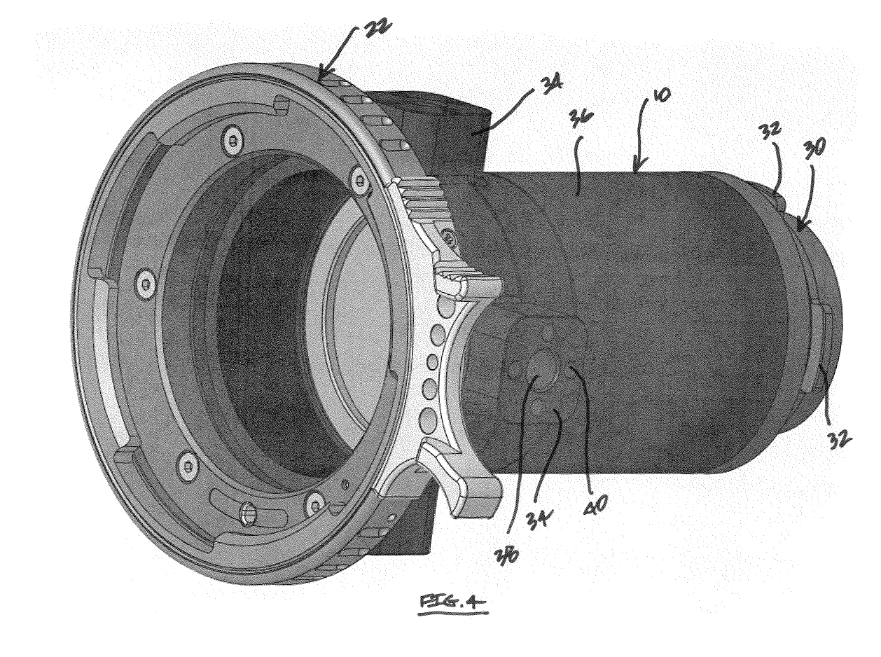

FIG. 3 illustrates an example optical relay device 10 as disclosed herein comprising a first attachment mechanism 22 at the first axial end of the optical relay device, and comprising a second attachment mechanism 24 at the second axial end of the optical relay device. In an example, the first and second attachment mechanisms 22 and 24 are configured to provide a releasable attachment or connection with axial ends of the respective first camera lens and second camera lens. In an example, the first and second attachment mechanisms 22 and 24 are configured to move from a locked to an unlocked position, e.g., locking and unlocking the optical relay device to the respective first and second camera lenses, by sliding back and forth rotational movement of respective levers 26 and 28. Also illustrated is the use of the enclosure or cage 16 around the portable device 14 to stabilize the attachment or connection of the optical relay device adjacent to the second camera lens. Also illustrated is the optional use of the hood 18 for enabling a clearer view of the portable device screen by shielding the screen from ambient surrounding light.

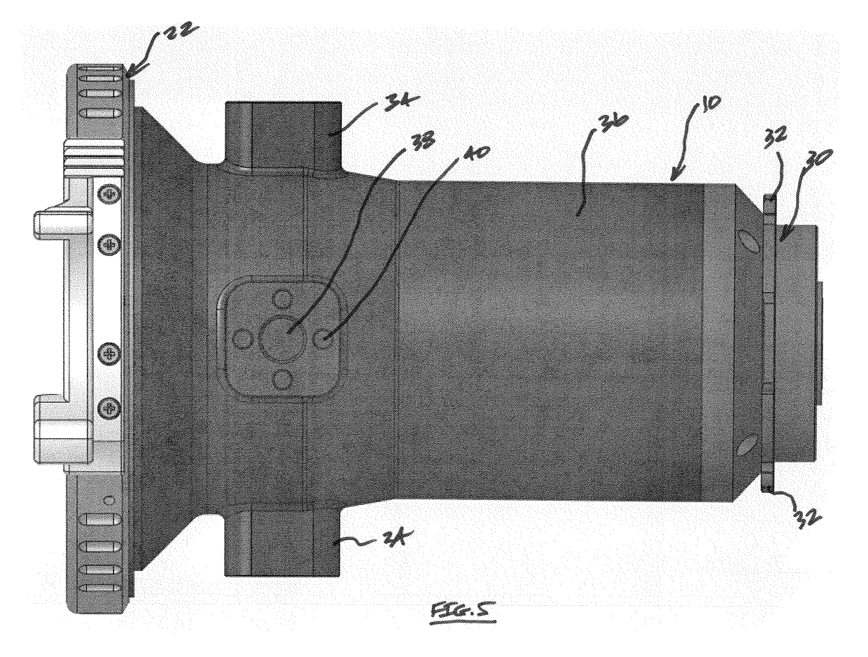

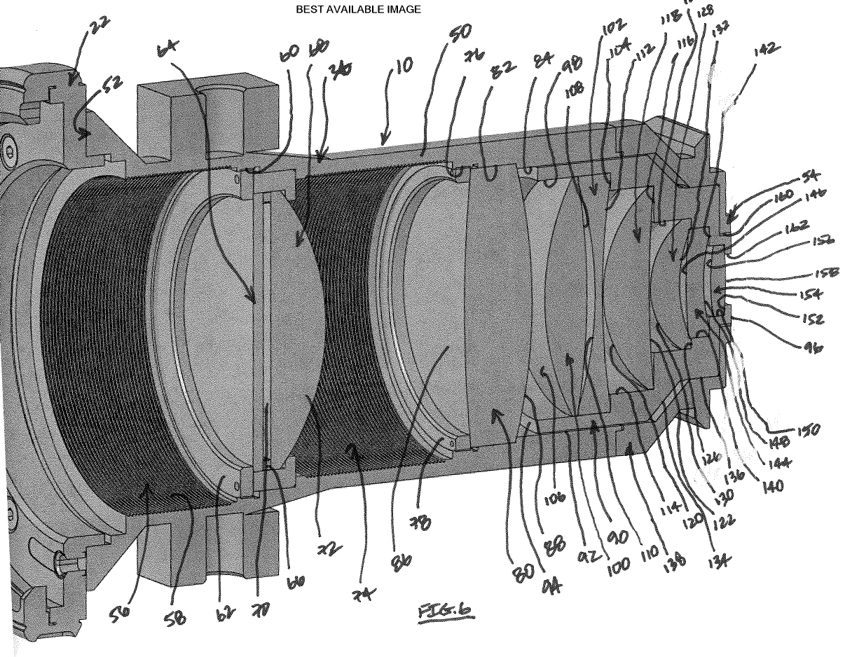

FIGS. 4 and 5 illustrate an example optical relay device 10 of FIG. 3 showing the first attachment mechanism 22 disposed along the first axial end of the optical relay device 10, and showing an attachment member 30 positioned adjacent the optical relay device second axial end. In an example, the attachment member 30 comprises a number of elements 32 projecting radially outwardly therefrom in the form of fins that are configured to register with inside surface features of the second attachment mechanism 24 (see FIG. 3) that is configured having an annular shape. In an example, the first attachment mechanism 22 is also configured having an annular shape with inside surface features configured to register with an axial end of the first camera lens. While particular examples of attachment mechanisms 22 and 24 and related attachment elements for connecting therewith have been described and illustrated, it is to be understood that attachment mechanisms and related attachment elements configured differently as described and illustrated may be used with optical relay devices as disclosed herein and are intended to be within the scope of this description.

Also illustrated in FIGS. 4 and 5 are mounting points 34 that are disposed along an outside surface of a housing 36 of the optical relay device 10. In the example illustrated, the optical relay device comprises a number of mounting points 32, e.g., four mounting points, that are located at 90 degree intervals around the housing 36 for purposes of providing alternative locations for attaching the optical relay device 10 to rigging equipment or the like. In an example, each mounting point 34 comprises a central opening 38, e.g., that may be a threaded opening, that extends a distance radially inwardly towards the housing, and a number of smaller openings 40 disposed around the central opening 38, for purposes of securing attachment of the mounting point to rigging equipment or the like. While particular examples of mounting points 34 and related mounting point openings 38 and 40 and related configurations of the same for attaching the optical relay device 10 to rigging equipment or the like have been described and illustrated, it is to be understood that optical relay device mounting points and related openings therein configured differently as described and illustrated may be used with optical relay devices as disclosed herein and are intended to be within the scope of this description.

FIGS. 6 and 7 illustrate an example optical relay device 10 as disclosed herein, and particularly illustrate the housing 36, an example configuration inside the housing, along with a variety of example optical and non-optical elements disposed therein. In an example, the optical relay device housing 36 comprises a cylindrical wall structure 50 extending between the first axial end 52 (positioned at a front location of the housing 36) and the second axial end 54 (positioned adjacent a rear location of the housing 36). An internal opening 56 having a round cross section throughout extends axially within the housing 36 between the first and second axial ends 52 and 54. The first attachment mechanism 22 is fixedly attached to the housing first axial end 52, e.g., by screwed attachment or the like. Moving from left to right, the housing internal opening 56 includes a first diameter section 58 that extends axially inwardly a distance from the first axial end 52. In a particular embodiment, the first diameter section 58 may have a diameter that is sized to accommodate an image as projected by the first camera lens (connected at the first axial end 52) without obstructing or otherwise impairing the image. In a particular example, where the first camera lens is a large format lens such as a Panavision Ultra Panatar II prime lens, the first diameter section 58 may have a diameter of from about 57.15 to 62.23 mm, and approximately 59.95 mm, and in such example the first diameter section 58 may extend axially a distance of from about 19.05 to 31.75 mm, and approximately 22.35 mm. In an example, the first diameter section 58 may have an inside surface configured having a plurality of radially arrange ribs disposed axially therealong. In an example, the plurality of ribs is provided to reduce internal reflections from stray light.

The first diameter section 58 extends axially in the internal opening 56 to a first reduced diameter shoulder 60 that is configured to accommodate placement of a first lens retaining element 62 therein. In an example, the first lens retaining element 62 is annular and is configured to accommodate placement of a flat protective circular glass piece 64, an annular spacer element 66, and a first lens or first lens element 68 therein, wherein the annular spacer element 66 operates to axially distance the glass piece 64 from the first lens 68 a desired amount. In a particular example, the protective circular glass piece 64 may have a diameter of from about 45.72 to 50.8 mm, and approximately 50.04 mm. The first lens retaining element 62 is fixedly attached within the first reduced diameter shoulder 60 by conventional attachment means. In an example, the flat protective glass piece 64 is optional and is provided to protect the internals of the optical relay device inside the housing from dust intrusion and the like. In an example, the first lens 68 is a spherical lens having a plano convex configuration for the purpose of bending the light rays inward/reducing the ray bundle. In an example, the flat surface 70 of the first lens 68 is positioned adjacent the glass piece 64, and the convex surface 72 of the first lens 68 is positioned away from the glass piece 64. In an example, the first lens 68 has a circular diameter of from about 45.72 to 50.8 mm, and approximately 50.05 mm, an axial thickness as measured at the apex of the convex surface 72 of from about 10.67 to 11.18 mm, and approximately 10.92 mm, and the convex surface 72 has a radius of curvature of from about 38 to 40 mm, and approximately 38.7 mm. In an example, the protective glass piece 64 and the first lens 68 may be referred to a field lens assembly comprising the two field lenses or field lens elements of the optical relay device (64 and 68), and are preferably both spherical.

Moving axially inwardly within the housing internal opening 56 from the first lens 68, a second diameter section 74 extends axially a distance away from the first lens 68 to a second reduced diameter shoulder 76, wherein the second reduced diameter shoulder 76 is configured to accommodate placement of a second lens retaining element 78 therein. In an example, the second diameter section 74 has an inside diameter that is smaller than the first diameter section 58. The second diameter section 74 may have a diameter of from about 52.07 to 54.16 mm, and approximately 53.34 mm, and in such example the second diameter section 74 may extend axially a distance of from about 30.48 to 33.02 mm, and approximately 31.50 mm. In an example, the second diameter section 74 may have an inside surface configured having a plurality of radially arrange ribs disposed axially therealong like the first diameter section 58 for the same purpose as described above.

In an example, a second lens 80 that is spherical is disposed in a third reduced diameter shoulder 82 that extends axially a distance away from the second reduced diameter shoulder 76. In an example, the third reduced diameter shoulder 82 may have the same or smaller inside diameter as the second reduced diameter shoulder 76 and extends a distance axially to a fourth reduced diameter shoulder 84. In an example, the third reduced diameter shoulder 82 has an inside diameter and an axial length sized to accommodate placement of the second lens 80 therein, and the second lens 80 is fixed in the third reduced diameter shoulder 82 by fixed placement of the second lens retaining element 78 that is annular in configuration in the second reduced diameter shoulder 76 by conventional means. In an example, the second lens 80 has a biconvex configuration, wherein a convex surface 86 adjacent the first lens 68 has a radius of curvature that is greater than an opposed convex surface 88. In an example, the second lens convex surface 86 has a radius of curvature of approximately 241.6 mm, and the second lens convex surface 88 has a radius of curvature of approximately 96.8 mm. In an example, the second lens 80 has an axial thickness as measured between the apexes of the opposed convex surfaces of approximately 13.21 mm. In an example, the second lens 80 has a circular outside diameter that is approximately the same as the first lens 68. In an example, the axial distance between the first lens convex surface 72 and the second lens convex surface 86, as measured between the apexes, is approximately 27.69 mm.

Moving axially away from the second lens 80, in an example, a lens fixture element 90 is disposed in the internal opening 74 and is configured to accommodate a number of lenses having different outside diameters and at desired spacing therein. In an example, the lens fixture element 90 is used to provide this feature without the need for specially configuring the inside surface of the housing internal opening 74 to accommodate the different lens diameters and spacing therein. However, it is to be understood that specially configuring the inside surface of the housing internal opening 74 to accommodate the number of lenses is understood to be within the scope of the optical relay device as disclosed herein. In an example, the lens fixture element 90 is made, molded or machined, from a structurally rigid material such as those materials conventionally used in camera lenses, e.g., metallic materials and the like.

In an example, the lens fixture element 90 is configured having a circular first outside diameter section 92 that is sized to fit within the fourth reduced diameter shoulder 84 of the internal opening 74 and that extends axially a distance from a first axial end 94 of the lens fixture element, which end is positioned an axial distance away from the second lens 80. The lens fixture element 90 has a circular internal opening that extends axially therethrough from the first axial end 94 to a second opposed axial end 96, wherein the opening comprises a number of differently sized inside diameter sections. The first outside diameter section 92 comprises a first inside diameter section 98 that is sized to accommodate placement of a third lens 100 and fourth lens 102 therein. In an example, the first inside diameter section 98 extends axially a distance to a first reduced diameter shoulder 104 that functions to fix placement of the lenses disposed within the first inside diameter section 98.

A third lens 100 is disposed within the lens fixture element 90 inside the first inside diameter section 98 and is positioned axially a distance from the second lens 80. The third lens 100 is a spherical lens having a circular outside diameter that is smaller than that of the second lens 80 for the purpose of reducing the size of the image received from the second lens. In an example, the third lens 100 has an outside diameter of approximately 42.93 mm. In an example, the third lens 100 has a biconvex configuration. In an example, the third lens 100 has a convex surface 106 adjacent the second lens 80 having a radius of curvature that is less than an opposed third lens convex surface 108. In an example, the third lens convex surface 106 has a radius of curvature of approximately 44 mm, and the third lens convex surface 108 has a radius of curvature of approximately 124 mm. In an example, an axial distance between the second lens convex surface 88 and the third lens convex surface 106 as measured between respective apexes is approximately 2.54 mm.

Positioned adjacent the third lens 100 is a fourth lens 102 that is spherical and that has a circular outside diameter that is the same as the third lens. In an example, the fourth lens has a biconcave configuration. In an example, the fourth lens 102 has a concave surface 110 adjacent the third lens 100 that has a radius of curvature that is less than an opposed fourth lens concave surface 112. In an example, the fourth lens concave surface 110 has a radius of curvature of approximately 62 mm, and the fourth lens concave surface 112 has a radius of curvature of approximately 130 mm. In an example, the third and fourth lenses 100 and 102 are positioned adjacent and axially distanced apart, as measured between an apex of the third lens convex surface 108 and a low point of the fourth lens concave surface 110 approximately 1.65 mm. In an example, the fourth lens 102 is axially fixed against the first diameter reduced shoulder 104. While not shown, an annular retaining element or the like may be used to axially fix the third and fourth lenses 100 and 102 within the first reduced diameter section 98.

A second reduced diameter section 114 extends axially a distance from the first reduced diameter shoulder 104 to a second reduced diameter shoulder 116. In an example, a fifth lens 118 is disposed in the second reduced diameter section 114 and is a spherical lens having a circular outside diameter that is less than that of the third and fourth lenses 100 and 102 for the purpose of further reducing the size of the image received from the fourth lens 102. In an example, the fifth lens 118 has a circular outside diameter of approximately 36.58 mm. In an example, the fifth lens 118 has a convex concave configuration. In an example, the fifth lens 118 has a convex surface 120 adjacent the fourth lens 102 having a radius of curvature of approximately 22.8 mm, and has a concave surface 122 having a radius of curvature of approximately 179 mm. In an example, the fifth lens 118 concave surface 122 has a more aggressive concave shape than as illustrated. In an example, an axial distance between the fourth lens concave surface 112 and the fifth lens convex surface 120 as measured between the convex surface apex and the lowest point of the concave surface is approximately 0.13 mm. The fifth lens 118 is fixed axially against the second reduced diameter shoulder 116. While not shown, an annular retaining element or the like may be used to axially fix the fifth lens 118 within the second reduced diameter section 114.

A third reduced diameter section 124 extends axially a distance from the second reduced diameter shoulder 116 to a third reduced diameter shoulder 126. In an example, a sixth lens 128 is disposed in the third reduced diameter section 124 and is a spherical lens having a circular outside diameter that is less than that of the fifth lens 118 for the purpose of further reducing the size of the image received from the fifth lens 118. In an example, the sixth lens 128 has a circular outside diameter of approximately 0.23.62 mm. In an example, the sixth lens 128 has a convex concave configuration. In an example, the sixth lens 128 has a convex surface 130 adjacent the fifth lens 118 having a radius of curvature of approximately 14 mm, and has an opposed concave surface 132 having a radius of curvature of approximately 24 mm. In an example, an axial distance between the fifth lens concave surface 122 and the sixth lens convex surface 130 as measured between the respective lowest point of the concave surface and apex of the convex surface is approximately 0.20 mm. The sixth lens 128 is fixed axially against the third reduced diameter shoulder 126. While not shown, an annular retaining element or the like may be used to axially fix the sixth lens 128 within the third reduced diameter section 124.

In an example, the lens fixture element 90 comprises a radially inwardly tapered section 134 that extends axially from the first outside diameter section 92 to a second outside diameter section 136 that has a smaller outside diameter than the first outside diameter second 92. The radially inwardly tapered section 134 is located between the second reduced diameter section 114 and the third reduced diameter section 124. In an example, the lens fixture element 90 is configured in such manner to accommodate fitment of a housing end member 138 thereover as better explained below.

A fourth reduced diameter section 140 extends axially a distance from the third reduced diameter shoulder 126 to a fourth reduced diameter shoulder 142. In an example, a seventh lens 144 is disposed in the fourth reduced diameter section 140 and is a spherical lens having a circular outside diameter that is less than that of the sixth lens 128 for the purpose of further reducing the size of the image received from the sixth lens 128. In an example, the seventh lens 144 has a circular outside diameter less than that of the sixth lens 128 of approximately 19.81 mm. In an example, the seventh lens 144 has a concave convex configuration. In an example, the seventh lens 144 has a convex surface 146 adjacent the sixth lens 128 having a radius of curvature of approximately 95 mm, and has an opposed concave surface 148 having a radius of curvature of approximately 31.8 mm. In an example, an axial distance between the sixth lens concave surface 132 and the seventh lens convex surface 146 as measured between the respective lowest point of the concave surface and apex of the convex surface is approximately 1.30 mm. The seventh lens 144 is fixed axially against the fourth reduced diameter shoulder 142. While not shown, an annular retaining element or the like may be used to axially fix the seventh lens 144 within the fourth reduced diameter section 140.

A fifth reduced diameter section 150 extends axially a distance from the fourth reduced diameter shoulder 142 to a fifth reduced diameter shoulder 152. In an example, an eighth lens 154 is disposed in the fifth reduced diameter section 150 and is a spherical lens having a circular outside diameter that is less than that of the seventh lens 144 for the purpose of further reducing the size of the image received from the seventh lens 144. In an example, the eighth lens 154 has a circular outside diameter of approximately 12.95 mm. In an example, the eighth lens 154 has a biconvex configuration. In an example, the eighth lens 154 has a convex surface 156 adjacent the seventh lens 144 having a radius of curvature of approximately 38.1 mm, and has an opposed convex surface 158 having a radius of curvature of approximately 43.2 mm. In an example, an axial distance between the seventh lens concave surface 148 and the eighth lens convex surface 156 as measured between the respective lowest point of the concave surface and apex of the convex surface is approximately 1.42 mm. The eighth lens 154 is fixed axially against the fifth reduced diameter shoulder 152. While not shown, an annular retaining element or the like may be used to axially fix the eighth lens 154 within the fifth reduced diameter section 150.

In an example, the housing end member 138 is attached to the housing 36, and around a portion of the lens fixture element 90 otherwise protruding from an open end of the housing. In an example, configuring the optical relay device in this manner comprising the lens fixture element 90 and the housing end member 138 enables the lenses 100, 102, 118, 128, 144, and 154 to be assembled before being loaded into the housing internal opening 74. The housing end member 138 includes the second axial end of the housing 54 that comprises an opening 160 that is sized to permit a portion the second axial end 96 of the lens fixture element to protrude outwardly therefrom. The lens fixture element 90 second axial end 96 includes an opening 162 that is sized to permit the image processed by the optical relay device to be transmitted outwardly from the optical relay device for image capture by the second camera lens and camera of the portable device camera system.

The example optical relay device illustrated in FIGS. 7 and 8 comprise lenses that provide a Positive (+) Negative (−) Negative (−) Positive (+) (PNNP) power structure or distribution within the optical relay device. In such example, the second lens 80 has a positive (+) power, the third and fourth lenses 100 and 102 when combined produce a negative (−) power, the fifth lens and the sixth lenses 118 and 128 when combined produce a negative (−) power, and the seventh and eighth lenses 144 and 154 when combined produce a positive (+) power. The balance of positive and negative power within the optical relay device provided by the PNNP power structure is utilized to reduce the field curvature. Secondly, the symmetry of the PNNP set up of the optical relay device helps in the correction of field driven aberrations via the symmetry of the relay cancelling out the offending aberrations.

While an example optical relay device has been disclosed and illustrated in FIGS. 6 and 7 as comprising lenses that are all spherical, it is to be understood that optical relay devices as disclosed herein may also be configured having a lens group comprising one or more anamorphic or cylindrical lenses to produce an anamorphic image. FIG. 8 illustrates an optical relay device 180 as disclosed here comprising a lens group that comprises one or more anamorphic or cylindrical lenses or lens elements. In an example, such optical relay device 180 comprises (though not shown in FIG. 8) the same two field lenses, for the example optical relay device disclosed above and illustrated in FIGS. 6 and 7 (i.e., the protective glass piece 64 and the first lens 68.

Moving from the top to the bottom of FIG. 8 (which is the equivalent of moving from left to right in FIGS. 6 and 7), the optical relay device 180 comprises a second lens 200 that is a cylindrical lens and that has a bi-convex cylindrical configuration. In this example, the second lens 200 replaces the second and third lenses 80 and 100 of the earlier disclosed spherical optical relay device example. The removal of the two spherical lenses 80 and 100 of the earlier-described optical relay device and replacement with a positive cylindrical lens 200 operates to create the object side of the anamorphic Brevais within the system. The positive cylindrical lens 200 is paired to a third lens 202 that is negative cylindrical lens 202 rearward of the positive cylindrical lens 200. The positive cylindrical lens 200 is composed of a low dispersion glass type that useful for a desired color correction within the optical relay device 180.

Moving down from the second lens 200, the optical relay device 180 comprises a third lens 202 that is a cylindrical lens and that has a bi-concave cylindrical configuration. In an example, the second and third lenses 200 and 202 are oriented within the optical relay device 180 in a manner that such that the powered axis of each lens 200 and 202 are aligned with each other. The particular shapes of the lenses 200 and 202 function to create a desired anamorphic image onto an image sensor of the second camera lens. In an example, the shape of the lenses 200 and 202 creates an anamorphic Brevais in which the sagittal and tangential relay bundle are parfocal to one another at the intermediate imaging plane. In an example, the second and third lenses 200 and 202 when combined produce a positive (+) power structure or distribution. Though the power configuration of the cylinders within the anamorphic optical relay device 180 remains the same (e.g., lens 200 is positive (+) and lens 202 is negative (−)), there is a case of different formats in which the shape of the cylinders can change. For example, there is a case in which the radii of the positive and negative cylinders 200 and 202 can change to create a different anamorphic squeeze ratio. However, even with the change in radii the net power sum of the two cylinders 200 and 202 should remain positive. In an example, the net power of the anamorphic optical relay device 180 is set to 3× anamorphic squeeze. In an example, the anamorphic lenses 200 and 202 of the optical relay device 180 may be configured to provide an anamorphic squeeze of from about 1.35× to about 3×.

Moving down from the third lens 202, the optical relay device 180 comprises a fourth lens 204 that is a spherical lens and that has a convex surface facing the third lens 202 and a concave surface facing away from the third lens 202. In an example, the fourth lens 204 has a negative (−) power. In an example, the fourth lens 204 has a meniscus shape that is configured to reduce field aberrations such as distortion and astigmatism. The negative power of the fourth lens 204 also functions to reduce the Petzval sum of the optical relay device 180 lens system.

Moving down from the fourth lens 204, the optical relay device 180 comprises a fifth lens 206 that is a spherical lens and that has a convex surface facing the fourth lens 204 and a concave surface facing away from the fourth lens 204. In an example, the fifth lens 206 has a negative (−) power. In an example, the fifth lens 206 is shaped to help reduce astigmatism and field curvature of the optical relay system 180.

Moving down from the fifth lens 206, the optical relay device 180 comprises a sixth lens 208 that is a spherical lens and that has a convex surface facing the fifth lens 206 and a concave surface facing away from the fifth lens 206. In an example, the sixth lens 208 is configured to reduce the spherical aberration of the optical relay device 180 as well as preserve the balance of power within the optical relay device 180.

Moving down from the sixth lens 208, the optical relay device 180 comprises a seventh lens 210 that is a spherical lens having bi-convex surfaces. In an example, the seventh lens 210 is configured utilizing low dispersion elements to reduce chromatic contributions. The shape of the seventh lens 210 assists with reducing Petzval sum and reducing spherical aberration within the system. In an example, the sixth and seventh lenses 208 and 210 when combined produce a positive (+) power structure or distribution. Thus, in an example anamorphic optical relay device 180 the overall power structure provided by the lens group is PNNP.

Though not illustrated in FIG. 8, the example anamorphic optical relay device 180 comprising the lenses disclosed above makes use of the same or similar lens mounting, and spacing devices, and lens internal retaining elements as disclosed above with reference to the example optical relay device illustrated in FIGS. 6 and 7.

In an example, optical relay devices as disclosed herein (both spherical as illustrated in FIGS. 6 and 7, and anamorphic as illustrated in FIG. 8) may be used with first cameras having a lens, e.g., objective lens, that is spherical. However, there may be an option to use a first camera having an anamorphic objective lens to either of the optical relay devices (spherical or anamorphic) to exaggerate or reduce the out-of-focus characteristics of the image captured onto the second camera device imager or digital sensor.

In an example, the anamorphic embodiment of the optical relay device can create a portrait aspect ratio versus a traditional landscape aspect ratio. The landscape version would be amenable to the growing trend of negative aspect ratio presentation formats. With reference to FIG. 8, a full aperture stop area 185 of the objective or first lens 190 coincides with the imager or digital sensor 212 of the second camera. This type of imager allows a cellular phone such as the Apple iPhone relay to image the objective lens 190 onto the device imager 212 without the use of a ground glass, i.e., such that optical relayed devices as disclosed here do not make use of a ground glass of intermediate imaging. If desired, the depth of field of the relay can be controlled by the addition of a holographic diffuser inserted into the intermediate image plane between the relay and the objective lens.

In an example, for either embodiment of the optical relay device (spherical is illustrated in FIGS. 6 and 7, or anamorphic as illustrated in FIG. 8), the second camera has a taking lens that is spherical. In an example, the anamorphic optical relay device as disclosed herein serves two purposes. In the case of “Verticals” the anamorphic optical relay device can be oriented in its normal 9×16 format invert the image to a 16×9 release or the inverse can be applied in which the optical relay device is horizontal, and the release image can be squeezed, and the resulting image is a 9×16 format. The anamorphic grouping can orient in either the horizontal or vertical biased direction depending on the final image capture format. Additionally, while the anamorphic squeeze of the optical relay device has been disclosed has being limited to one or a range of anamorphic squeeze ratios, optical relay devices as disclosed herein may be altered to accommodate a host of other formats that can evolve with trends among the end user preferences. In an example, optical relay devices as disclosed herein are configured to provide a desired reduction in the image size of the image received by the first camera lens for image capture by the camera system of the small portable device, e.g., in the form of a cellular phone or smart phone such as an Apple iPhone or the like.

Optical relay devices as disclosed herein are configured for use in providing a desired degree of image reduction when used with any type of large format lens, e.g., spherical, and/or anamorphic lenses. A feature of optical relay devices as disclosed herein is that they are configured such that the lenses or lens elements disposed therein are aligned along the same optical axis as the first camera lens and the second camera lens connected thereto and is optically telecentric, i.e., the optical relay device is a telecentric optical system.

A further feature of optical relay devices as disclosed herein is that they are configured in a manner that intentionally avoids the need to use a ground glass element for purposes of providing an intermediate image. Rather, optical relay devices as disclosed herein are specially developed to provide an aerial or intermediate image in an open image plane within the optical relay device, where two images coincide at the intermediate for relay from the first camera lens to the second camera lens through the use of the specific lenses or lens system described above. Avoiding the use of a ground glass element functions to produce an image that is optically cleaner and clearer.

While particular quantities, types, sizes, and/or placement positions of lenses or lens elements used inside optical relay devices as disclosed herein have been described and illustrated, it is to be understood that the quantity, types, sizes, and/or placement positions of lenses used inside optical relay devices as disclosed herein may change depending on the second camera system of the portable device, e.g., such factors as the second camera system lens configuration, the second camera system image sensor configuration, device space or packaging constraints, the image processing software that is used by the second camera system, and the like. Accordingly, it is to be understood that all such changes or variations in the quantity, types, sizes, and/or placement positions of lenses used inside optical relay devices as disclosed herein are understood to be within the scope of optical relay devices as disclosed herein. Further, while the lenses used in the optical relay device have been described individually, it is understood that certain combinations of lenses or lens elements may be combined into a lens group. For example, lenses 2 through 8 (for the nonanamorphic example) and lenses 2 through 7 (for the anamorphic example) may be referred to as being lens elements of a lens group, and such is understood to be within the scope of optical relay devices as disclosed herein.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of devices, apparatuses, systems, and/or methods as disclosed herein, which is defined solely by the claims. Accordingly, the devices, systems, apparatuses, and/or methods are not limited to that precisely as shown and described.

Certain embodiments of devices, systems, apparatuses, and/or methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the devices, systems, apparatuses, and/or methods include all modifications and equivalents of the subject matter recited in the claims appended hereto as permitted by applicable law. Moreover, any combination of the above-described embodiments in all possible variations thereof is encompassed by the devices, systems, apparatuses, and/or methods unless otherwise indicated herein or otherwise clearly contradicted by context.

Groupings of alternative embodiments, elements, or steps of the devices, systems, apparatuses, and/or methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary, yet is capable of performing the desired operation or process discussed herein.

The terms “a,” “an,” “the” and similar referents used in the context of describing the devices, systems, apparatuses, and/or methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the devices, systems, apparatuses, and/or methods and does not pose a limitation on the scope of the devices, systems, apparatuses, and/or methods otherwise claimed. No language in the present specification should be construed as indicating any non-claimed element essential to the practice of the systems, apparatuses, and methods.

What is claimed is:

1. An optical relay device comprising:
a housing having a first axial end and a second axial end opposite the first axial end, wherein the housing comprises a wall structure that defines an internal opening extending axially through the housing between the first and second axial ends, wherein the first axial end is configured to connect with an end of a first camera lens, and wherein the second axial end is configured to connected with a second camera lens of a camera system comprising a camera for image capture, wherein the first camera lens is larger in diameter that the second camera lens, and wherein the housing wall structure has an outside surface configured to accommodate attachment with a mounting device; and
a lens group that is disposed within the housing and located between the housing first and second axial ends, wherein the lens group comprises a plurality of lens elements that are configured and positioned to converge and reduce the image as received by the first camera lens to an image that corresponds to the second camera lens for image capture by the camera system camera;
wherein the first camera lens and second camera lens are aligned along a common optical axis that extends through the optical relay device, and wherein the optical relay device is telecentric.

2. The device of claim 1, wherein the lens group is configured to produce an aerial intermediate image within the housing between the first and second camera lenses without the use of a ground glass element.

3. The device of claim 1, wherein the plurality of lens elements of the lens group are each fixedly attached and not movable within the housing internal opening.

4. The device of claim 1, wherein at least one lens element of the lens group is cylindrical to provide an anamorphic image, and wherein the optical relay device has an anamorphic squeeze of from about 1.35× to about 3×.

5. The device of claim 1, wherein the lens group comprises a PNNP power structure.

6. The device of claim 1, wherein the plurality of lens elements making up the lens group are each spherical.

7. The device of claim 6, wherein the lens group comprises eight lens elements.

8. The device of claim 7, wherein the lens elements comprise:
a first lens positioned adjacent the housing first axial end and having a plano-convex configuration;
a second lens positioned adjacent the first lens and having a biconvex configuration;
a third lens positioned adjacent the second lens and having a biconvex configuration;
a fourth lens positioned adjacent the third lens and having biconcave configuration;
a fifth lens positioned adjacent the fourth lens and having a convex concave configuration;
a sixth lens positioned adjacent the fifth lens and having a convex concave configuration;
a seventh lens positioned adjacent the sixth lens and having a convex concave configuration; and
an eighth lens interposed between the seventh lens and the second axial end and having a biconvex configuration.

9. The device of claim 8, wherein the second lens has a first convex surface adjacent the housing first axial end defined by a radius of curvature that is greater than a second convex surface adjacent the third lens.

10. The device of claim 8, wherein the third lens has a first convex surface adjacent the second lens defined by a radius of curvature that is less than a second convex surface adjacent the fourth lens.

11. The device of claim 8, wherein the fourth lens has a first concave surface adjacent the third lens defined by a radius of curvature that is less than a second concave surface adjacent the fifth lens.

12. The device of claim 8, wherein the fifth lens has a convex surface adjacent the fourth lens defined by a radius of curvature that is less than a concave surface adjacent the sixth lens.

13. The device of claim 8, wherein the sixth lens has a convex surface adjacent the fifth lens defined by a radius of curvature that is less than a concave surface adjacent the seventh lens.

14. The device of claim 8, wherein the seventh lens has a convex surface adjacent the sixth lens defined by a radius of curvature that is less than a concave surface adjacent the eighth lens.

15. The device of claim 8, wherein the eighth lens has a first convex surface adjacent the seventh lens and a second convex surface adjacent the housing second axial end that have a radius of curvature that are approximately the same.

16. The device of claim 1, wherein the first camera lens is a large format camera lens, and the camera system and second camera lens is part a cellular phone or smartphone.

17. An optical relay system for relaying an image from an objective camera lens to a taking camera lens, the system comprising:
an elongate housing having a cylindrical inside wall that extends from an opening at a first housing axial end to an opening at an opposite second axial end, wherein a large format objective camera lens is connected with the first axial end, and wherein a taking lens of a small sensor camera is connected with the second axial end;
a lens group comprising a plurality of lenses disposed serially within the housing inside wall between the first and second axial ends, wherein the plurality of lenses are arranged along a common optical axis in the housing extending between the objective camera lens and the taking camera lens;
wherein the lens elements are at least one of configured or positioned in the housing to produce an intermediate image within the housing without the use of a ground glass element; and
wherein the lens elements are configured to produce a PNNP power structure in the lens group, and wherein the optical relay system is telecentric.

18. The system of claim 17, wherein two or more of the lenses are spherical, and wherein the lens group comprises at least two cylindrical lenses configured to produce an anamorphic image.

19. The system of claim 18 configured to produce an anamorphic squeeze of from about 1.35× to 3×.

20. The system of claim 17, wherein the plurality of lenses in the lens group are all spherical.
